(19) United States
(12) Patent Application Publication
(10) Pub. No.: US 2014/0020394 A1
(43) Pub. Date: Jan. 23, 2014

(54) SYSTEM AND METHOD FOR TURBOMACHINE HOUSING VENTILATION

(71) Applicants: Donald Gordon Laing, Houston, TX (US); Mehdi Milani Baladi, Cincinnati, OH (US); Gerardo Plata Contreras, Queretaro (MX); Luis Alonso Villegas Rivas, Queretaro (MX)

(72) Inventors: Donald Gordon Laing, Houston, TX (US); Mehdi Milani Baladi, Cincinnati, OH (US); Gerardo Plata Contreras, Queretaro (MX); Luis Alonso Villegas Rivas, Queretaro (MX)

(73) Assignee: GENERAL ELECTRIC COMPANY, Schenectady, NY (US)

(21) Appl. No.: 13/555,022

(22) Filed: Jul. 20, 2012

(51) Int. Cl. F02C 7/00

(52) U.S. Cl. CPC F02C 7/00
USPC 60/772; 60/722

(57) ABSTRACT

An air intake includes a conduit, an inlet, an inlet duct, an outlet duct, an outlet, and a fan. The inlet is configured to removably couple with the fan and to direct the second airflow in a first direction. The inlet duct is coupled to the inlet and directs the second airflow in a second direction around the conduit and a third direction into a turbomachine enclosure. The outlet duct receives the second airflow from a fourth direction substantially opposite to the third direction and directs the second airflow in the second direction. The outlet is configured to removably couple with the fan and to direct the second airflow in a fifth direction. The fan within the air intake is removably coupled to the inlet or to the outlet and is configured to positively or negatively pressurize the turbomachine enclosure with the second airflow based on the fan disposition.

### BACKGROUND OF THE INVENTION

The subject matter disclosed herein relates to turbomachines, and more specifically, to ventilation for a housing of a turbomachine.

In general, a turbomachine transfers energy between a mechanical system and a fluid. Some turbomachines, such as gas turbine engines, combust a mixture of compressed air and fuel to produce hot combustion gases. The compressed air is drawn from an air intake. A gas turbine engine produces work through expansion of combustion gases. A turbomachine (e.g., a gas turbine engine) or engine may be installed within an enclosure. However, some of the combustion gases may collect in the enclosure. Ventilation systems for the enclosure may be separate from the air intake or enclosure. Some ventilation systems may create a significant amount of noise.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes an air intake coupled to a turbomachine enclosure. The air intake is configured to produce a first airflow and a second airflow. The air intake includes a conduit, an inlet, an inlet duct, an outlet duct, an outlet, and a fan. The conduit is configured to direct the first airflow to a turbomachine subsystem within the turbomachine enclosure. The inlet is configured to removably couple with the fan and to direct the second airflow in a first direction. The inlet duct is coupled to the inlet, configured to direct the second airflow in a second direction at least partially around the conduit, and configured to direct the second airflow in a third direction into the turbomachine enclosure. The outlet duct is configured to receive the second airflow from the turbomachine enclosure from a fourth direction substantially opposite to the third direction. The outlet duct is configured to direct the second airflow in the second direction to an outlet. The outlet is configured to removably couple with the fan and to direct the second airflow from the turbomachine enclosure in a fifth direction. The fan is disposed within the air intake, is removably coupled to the inlet or to the outlet, and is configured to positively or negatively pressurize the turbomachine enclosure with the second airflow based on the orientation and disposition of the fan.

In a second embodiment, a system includes an enclosure surrounding a turbomachine subsystem and an air intake coupled to the enclosure. The air intake is configured to direct a first airflow to the turbomachine subsystem and to direct a second airflow to the enclosure. The air intake includes an inlet duct, an outlet duct, and a fan. The inlet duct is coupled to the enclosure and configured to receive the second airflow. The outlet duct is coupled to the enclosure and configured to direct the second airflow. The fan is removably coupled to the inlet duct to positively pressurize the enclosure or removably coupled to the outlet duct to negatively pressurize the enclosure.

In a third embodiment, a method includes directing a first airflow through a conduit to a gas turbine system disposed within an enclosure and receiving a second airflow from a first direction through an inlet configured to removably couple with a fan. The method also includes directing the second airflow in a second direction through an inlet duct at least partially around the first airflow, directing the second airflow in a third direction through the inlet duct into the enclosure, and receiving the second airflow from a fourth direction substantially opposite to the third direction through an outlet duct from the enclosure. The method also includes directing the second airflow in the second direction to an outlet, and directing the second airflow in a fifth direction from the outlet configured to removably couple with the fan, and pressurizing the enclosure with a positive or a negative pressure based on the orientation and disposition of the fan.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a turbine system having an air intake with a modular ventilation system;

FIG. 2 is a schematic of an embodiment of turbomachine system having an air intake with a modular ventilation system;

FIG. 3 is a top view of an embodiment of the air intake of FIG. 2;

FIG. 4 is a schematic of an embodiment of a positively pressurized enclosure; and

FIG. 5 is a schematic of an embodiment of a negatively pressurized enclosure.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

A modular ventilation system of an air intake has a modular and flexible design for the ventilation of an enclosure, e.g., for a turbomachine such as a gas turbine engine or a reciprocating engine. The inlet and outlet of the modular ventilation system are configured to removably couple with a fan to enable a switch from a positively pressurized enclosure to a negatively pressurized enclosure by changing only the location and orientation of the fan. The fan is configured to push or pull an airflow through the enclosure. The inlet, outlet, and fan are integrated within the air intake, which may attenuate the noise of the fan removably coupled to the inlet or the outlet. Vent silencers may also attenuate the noise. The inlet may be proximate the outlet to at least increase the ease of switching the location and orientation of the fan between the inlet and the outlet. The inlet and outlet ducts coupling the modular ventilation system to the enclosure are also integrated in the air intake. The inlet and outlet ducts enable the switch between a positively pressurized enclosure and a negatively pressurized enclosure without affecting the structure of the inlet and outlet ducts. The inlet and outlet ducts may be configured to route the airflow into the enclosure along defined relative directions. The airflow may flow through the inlet ducts and outlet ducts in substantially the same direction without regard to the location and orientation of the fan.

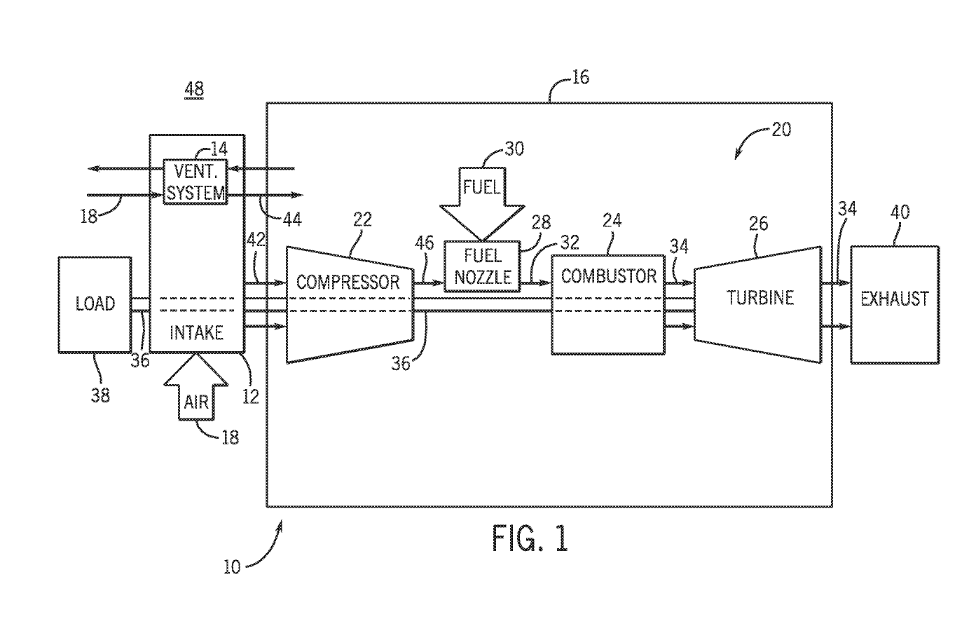

Turning now to the drawings and referring first to FIG. 1, a schematic diagram of an embodiment of a turbomachine system 10 is shown having an air intake 12 with a modular ventilation system 14. The air intake unit is coupled to an enclosure 16. As discussed in detail below, the air intake 12 receives air 18 from the ambient environment and directs the air 18 to the enclosure 16 and to subsystems 20 (e.g., gas turbine system) within the enclosure 16. The subsystem 20 may include, but is not limited to, a gas turbine system having a compressor 22, a combustor 24, and a turbine 26. In other embodiments, the subsystem 20 may be an engine (e.g., internal combustion engine). The gas turbine system may employ one or more fuel nozzles 28 to route a fuel 30 (e.g., a liquid fuel and/or gas fuel, such as natural gas) into the combustor 24. The combustor 24 ignites and combusts the air-fuel mixture 32, and then passes hot pressurized exhaust gas 34 into the turbine 26. The exhaust gas 34 passes through turbine blades of the turbine 26, thereby driving the turbine 26 to rotate about the shaft 36. The shaft 36 drives the compressor 22 and/or a load 38. As appreciated, the load 38 is any suitable device that generates power via the rotational output of the subsystem 20, such as a power generation plant or an external mechanical load. For example, the load 38 may include an electrical generator, a propeller of an airplane, a pump, compressor, and so forth. Eventually, the exhaust gas 34 of the combustion process may exit the turbomachine system 10 via an exhaust outlet 40.

The compressor 22 or other component draws air 18 into the subsystem 20 via the air intake 12. The air intake 12 draws air 18 into the turbomachine system 10 via a suitable mechanism, such as a cold air intake, and produces a first airflow 42 and a second airflow 44. The first airflow 42 may be for mixture of air 18 with the fuel 30 via fuel nozzle 28. Air 18 taken in by subsystem 20 may be compressed into pressurized air 46 by rotating blades within compressor 22. The pressurized air 46 may then be fed into one or more fuel nozzles 28. Fuel nozzles 28 may then mix the pressurized air 46 and fuel 30, to produce the suitable air-fuel mixture 32 for combustion, e.g., a combustion that causes the fuel 30 to more completely burn, so as not to waste fuel 30 or cause excess emissions in the exhaust gas 34. Again, the turbine 26 is driven by the exhaust gases 34.

The second airflow 44 is drawn through a modular ventilation system 14 for cooling of the subsystem 20 and its components (e.g., compressor 22, combustor 24, turbine 26) and ventilation of the enclosure 16. The second airflow 44 may substantially isolate the enclosure 16 from the ambient environment 48 or substantially isolate the ambient environment 48 from the enclosure 16. For example, a positively pressurized enclosure 16 may substantially isolate the enclosure 16 from the ambient environment 48. A negatively pressurized enclosure 16 may substantially isolate the ambient environment 48 from the enclosure 16. The modular ventilation system 14 is integrated with the air intake 12 and includes a fan or other apparatus configured to produce the second airflow 44. The modular ventilation system 14 is configured for readily interchanging the pressurization and/or ventilation direction of the enclosure 16, such as by changing the orientation or the location of fan. The enclosure may contain noise produced by the turbomachine system 10. For example, the enclosure 16 may have acoustic panels to reduce the perceptible noise outside the enclosure 16.

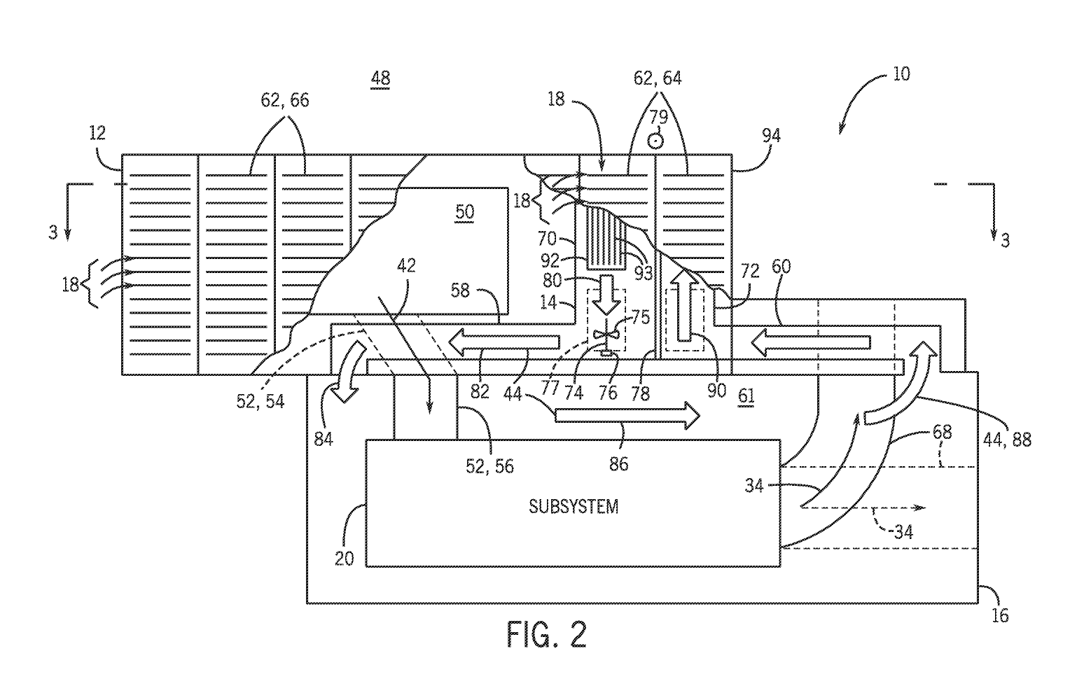

FIG. 2 illustrates the air intake 12 coupled to the enclosure 16. In some embodiments, the air intake 12 is a filter house configured to receive, filter, and distribute air 18 to the enclosure 16 and subsystem 20 (e.g., gas turbine system or compressor). The air intake 12 may be coupled above the enclosure 16 as shown in FIG. 2, or otherwise coupled adjacent to the enclosure 16. An intake system 50 in the air intake 12 supplies the first airflow 42 to the subsystem 20 via a conduit 52. The conduit 52 may have a first portion 54 integrated with the air intake 12 and a second portion 56 coupled to the subsystem 20. As discussed above, the subsystem 20 may be a turbomachine, such as a compressor, a turbine, a generator, a gas turbine system, and so forth. The modular ventilation system 14 is fluidly coupled to the enclosure 16 by inlet ducts 58 and outlet ducts 60. The modular ventilation system 14 supplies the second airflow 44 to the enclosure 16. The enclosure 16 is a structure surrounding the subsystem 20 and an interior chamber 61. The second airflow 44 may be configured to cool components of the subsystem 20 (e.g., compressor, combustor, turbine) that warm during operation of the turbomachine system 10 by flowing through the interior chamber 61. In some embodiments, the second airflow 44 is configured to ventilate the enclosure 16 to substantially prevent gases and/or particulates from accumulating within the interior chamber 61. The modular ventilation system 14 may supply fresh and/or filtered air to the interior chamber 61.

The air intake 12 may have a plurality of vanes 62 configured to guide air 18 in and out of the air intake 12. The plurality of vanes 62 may be fixed or adjustable. In some embodiments, the first set 64 of vanes 62 configured to guide air 18 into the modular ventilation system 14 may be adjustable separate from the remainder 66 of the vanes 62 into the intake system 50. In some embodiments, the second airflow 44 is configured to circulate through the enclosure 16 in substantially the same direction (e.g., downstream) as the first airflow 42. The first airflow 42 is configured to flow downstream from the intake system 50 to the exhaust outlet 68. As illustrated in FIG. 2, the second airflow 44 is configured to flow downstream through the inlet 70 of the modular ventilation system 14, the inlet duct 58, the interior chamber 61 of the enclosure 16, the outlet duct 60, and the outlet 72 of the modular ventilation system 14. In other embodiments, the second airflow 44 is configured to circulate through the enclosure in substantially the opposite direction (e.g., upstream) of the first airflow 42. For example, the second airflow 44 may be configured to flow upstream from the outlet 72 to the inlet 70.

The inlet 70 and outlet 72 of the modular ventilation system 14 are configured to removably couple with fan 74. The fan 74 may be coupled to either of the inlet 70 or outlet 72. For example, the inlet 70 and outlet 72 are similarly sized and configured to removably couple with the similarly sized inlet and outlet ducts 58, 60. In some embodiments, the fan 74 coupled to the inlet 70 has a geometry different from the fan 74 coupled to the outlet 72. The fan 74 removably coupled to the inlet 70 is also removably coupled to the inlet duct 58; the fan 74 removably coupled to the outlet 72 is also removably coupled to the outlet duct 60. The fan 74 may be configured to push or pull the second airflow 44 through the enclosure 16. In some embodiments, the flow direction or orientation of the fan 74 coupled to the inlet 70 or the outlet 72 may be readily changed. For example, the fan 74 may be removably coupled to the inlet 70 to push the second airflow 44 downstream through the enclosure 16 or to pull the second airflow 44 upstream. The fan 74 may be removably coupled to the outlet 72 to pull the second airflow 44 downstream through the enclosure 16 or to push the second airflow 44 upstream. In some embodiments, different types of fans 74 may be used based on the location (e.g., inlet 70 or outlet 72) and/or orientation (e.g., upstream or downstream). Types of fans 74 include, but are not limited to blower fans and suction fans. Some fans 74 may have blades 75 driven by a drive motor 76 and a housing 77 to support the motor 76 and protect the blades 75. The fan directs the air path through the housing 77. However, the drive motor 76 may be outside the housing 77 to enable air to flow through the fan 74 without exposing the drive motor 76 to the air. This may increase the operational temperature range of the fan 74 and/or decrease air obstruction through the housing 77. In some embodiments, the modular ventilation system 14 may have a plurality of fans 74 removably coupled in the inlet 70 or outlet 72.

The inlet ducts 58 and the outlet ducts 60 of the air intake 12 are configured to ease switching of the location and/or orientation of the fan 74. In some embodiments, the inlet 70 is adjacent to the outlet 72 and separated only by a removable partition 78. The partition 78 may be removable along a partition axis 79, a first direction 80, or a fifth direction 90 to provide ready access to the fan 74. For example, a railing 81 may enable the removable partition 78 to be moved to provide access to the fans without an overhead crane. The inlet 70 may be located proximate the outlet 72, such as within less than approximately 0.5 m, 1 m, or 2 m. In some embodiments, an adjustable port 83 (e.g., damper) through the partition 78 enables the second airflow 44 from the outlet duct 60 to enter the inlet duct 58. For example, when operating in low temperatures, the second airflow 44 from the outlet duct 60 may be warmer than the ambient environment 48. Recirculating at least a portion of the second airflow 44 from the outlet duct 60 through the damper 83 may warm the second airflow 44 to a desirable temperature for the subsystem 20. A desirable temperature may be greater than approximately −10° C., 0° C., 10° C., or 20° C. In some embodiments, the inlet 70 and outlet 72 are between the conduit 52 and the exhaust outlet 68. The inlet ducts 58 and outlet ducts 60 may have substantially similar structure to enable the fan 74 to be switched between the inlet 70 and outlet 72 without substantially affecting the quantity and/or direction of the second airflow 44. In some embodiments, the inlet and outlet ducts 58, 60 are configured so that the magnitude of the pressure difference between the enclosure 16 and the ambient environment 48 is substantially the same, without regard to whether the enclosure 16 is positively pressurized or negatively pressurized.

The inlet and outlet ducts 58, 60 are configured to direct the second airflow 44 along a defined route. For example, the second airflow 44 may be received through the inlet 70 from a first direction 80. The inlet duct 58 directs the second airflow 44 in a second direction 82. In some embodiments, the inlet duct 58 at least partially surrounds the conduit 52. The inlet duct 58 may direct the second airflow 44 at least partially around the first airflow 42 that flows through the conduit 52. For example, the second airflow 44 may pass through a first inlet duct portion 59 and/or a second inlet duct portion 63. The inlet duct 58 couples to the enclosure 16 and directs the second airflow 44 along the third direction 84 into the enclosure 16. In some embodiments, the second direction 82 may be substantially perpendicular to the first direction 80 and/or the third direction 84. The second airflow 44 flows through interior chamber 61 the enclosure 16 around the subsystem 20 as generally indicated by arrow 86. As discussed above, the second airflow 44 may cool the subsystem 20 and ventilate the enclosure 16. The outlet duct 60 is configured to receive the second airflow 44 from a fourth direction 88. The fourth direction 88 may be substantially opposite to the third direction 84. The outlet duct 60 directs the second airflow 44 in the second direction 82. In some embodiments, the second direction 82 is towards the outlet 72. The outlet duct 60 at least partially surrounds the exhaust outlet 68, and the outlet duct 60 directs the second airflow 44 at least partially around the first airflow 42 or exhaust gas 34 through the outlet duct 68. For example, the second airflow 44 may pass through a first outlet duct portion 69 and/or a second outlet duct portion 71. In some embodiments, the second airflow 44 cools the exhaust gas 34. The outlet 72 is configured to direct the second airflow 44 in a fifth direction 90 from the air intake 12. The second direction 82 may be substantially perpendicular to the fourth direction 88 and the fifth direction 90. As discussed in this example and shown in FIG. 2, the second airflow 44 may be pushed downstream by a fan 74 removably coupled in the inlet 70. The second airflow 44 may also be pulled downstream by a fan 74 removably coupled in the outlet 72. Alternatively, the fan 74 may be configured to direct the second airflow 44 upstream by removably coupling the fan 74 to the outlet 72 to push the second airflow 44 or removably coupling the fan 74 to the inlet to pull the second airflow 44. The inlet and outlet ducts 58, 60 are integrated with the air intake 12, so that the inlet and outlet ducts 58, 60 are substantially internal to the air intake 12. The integrated inlet and outlet ducts 58, 60 increase the modularity of the air intake 12 and reduce the time and costs associated with the installation of inlet and outlet ducts 58, 60 external to the air intake 12 at an operational location of the turbomachine system 10. The removable partition 78 reduces the time and cost associated with fan removal and maintenance by increasing the accessibility to the fans. In some embodiments, the removable partition 78 may be removable via the railing 81, rollers, pivot, and so forth.

The modular ventilation system 14 may be configured to attenuate noise from the fan 74 and/or second airflow 44 through the air intake 12. In some embodiments, the modular ventilation system 14 has a vent silencer 92. The inlet duct 58 and/or the outlet duct 60 may have a vent silencer 92. The vent silencer 92 may be at an end 94 of the modular ventilation system 14. The vent silencer 92 may include dampers 93 and/or baffles. The vent silencer 92 may have a plurality of acoustic dampening chambers between the dampers 93, each having one or more inlets. The air intake 12 may be configured to attenuate noise from the fan 74 through insulation and/or the location of the modular ventilation system 14 internally within the air intake 12. For example, the modular ventilation system 14 may be configured to attenuate noise by approximately 10%, approximately 20%, or approximately 30%. In some embodiments, the modular ventilation system 14 is configured to reduce the average sound power level below approximately 85, 80, 75, 70, or 65 dB around the enclosure 16.

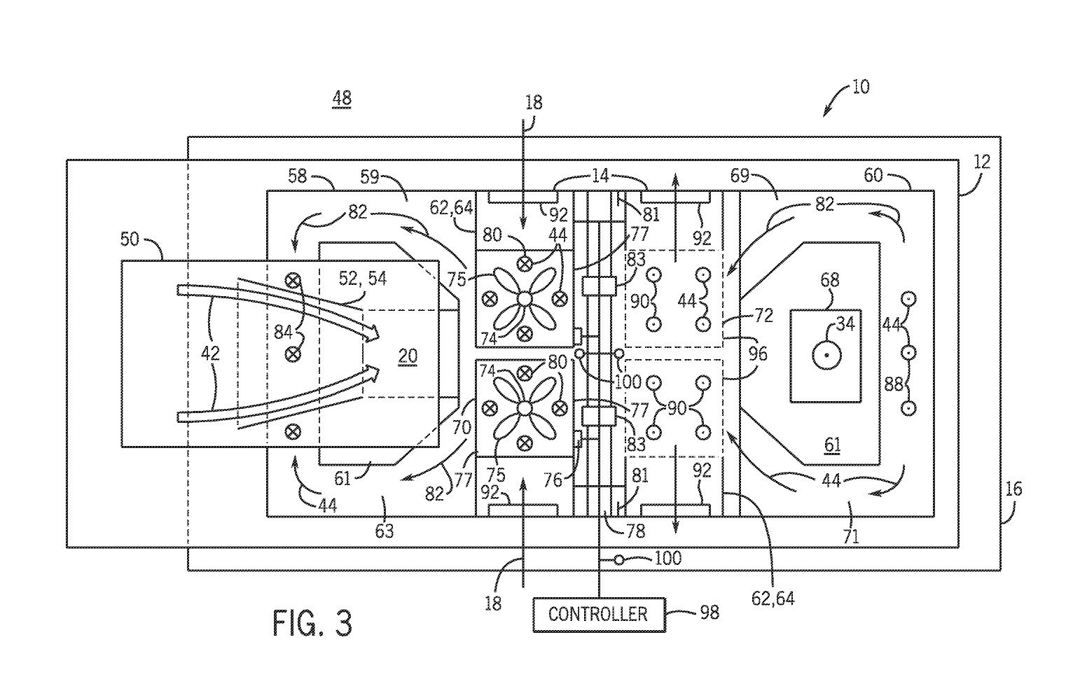

FIG. 3 illustrates an embodiment of the turbomachine system 10 of FIG. 2 taken along line 3-3. FIG. 3 illustrates a top-view of an embodiment of the air intake 12 and the modular ventilation system 14. The illustrated embodiment shows two fans 74 removably coupled in the inlet 70 configured to push the second airflow 44 through the enclosure 16. Other embodiments may have more than two fans 74 (e.g., three or four) or only one fan 74. In some embodiments, the inlet 70 and inlet ducts 58 may be substantially symmetrical about the partition 78 with the outlet 72 and outlet ducts 60. For example, the inlet ducts 58 may direct the second airflow 44 around the first airflow 42 through the conduit 52. The outlet ducts 60 may direct the second airflow 44 around the exhaust gases 34 that flow through the exhaust outlet 68.

As described above, both the inlet 70 and the outlet 72 are configured to removably couple with the one or more fans 74. In an embodiment as shown in FIG. 3, the fans 74 are removably coupled to the inlet 70 and configured to push the second airflow 44 downstream through the enclosure 16. Alternatively, the fans 74 may be removably coupled to the outlet 72 as shown by the dashed boxes 96 and configured to pull the second airflow 44 downstream through the enclosure 16.

The modular ventilation unit 14 is configured to receive the air 18 and direct the second airflow 44 in the first direction 80 (e.g., into the page of FIG. 3) to the inlet duct 58. The inlet duct 58 directs the second airflow 44 in the second direction 82 (e.g., along the page) around the conduit 52 and into the enclosure 16 in the third direction 84 (e.g., into the page). The outlet duct 60 receives the second airflow 44 from the fourth direction 88 (e.g., out from the page) from the enclosure 16 and directs the second airflow 44 in the second direction 82 around the exhaust outlet 68 to the outlet 72. The outlet 72 directs the second airflow 44 in the fifth direction 90 (e.g., out from the page) out from the air intake 12. In some embodiments, the first and third directions 80, 84 are substantially the same, the fourth and fifth directions 88, 90 are substantially the same, and the second direction 82 is substantially perpendicular to the first direction 80, third direction 84, fourth direction 88, and fifth direction 90. Directing the second airflow 44 upstream from the outlet 72 to the inlet 70 reverses the direction of the second airflow 44 as shown in FIG. 3. The configuration of the inlet and outlet ducts 58, 60 shown in FIG. 3 is an illustrative embodiment that is not intended to limit the shape and configuration of the inlet and outlet ducts 58, 60. For example, coupling the air intake 12 horizontally adjacent the enclosure 16 may not change the relative route of the second airflow 44 through the modular ventilation system 14.

In some embodiments, a controller 98 is coupled to the modular ventilation system 14 and is configured to monitor and control properties of the second airflow 44. The controller 98 may be configured to monitor the environment of the interior chamber 61 through one or more sensors 100. The one or more sensors 100 may include a pressure sensor, temperature sensor, or a gas detector (e.g., oxygen sensor), or any combination thereof The sensors 100 may be disposed in any of the enclosure 16, the inlet 70, the outlet 72, the inlet duct 58, and the outlet duct 60. In some embodiments, the controller 98 may control the drive motors 76 of the fans 74 to adjust the speed, mass flow, and direction of the fans 74 based at least in part on the feedback received from the sensors 100. The controller 98 may also be electrically coupled to the first set 64 of vanes 62 to control the quantity of air 18 flowing into and/or out of the modular ventilation system 14. In some embodiments, the controller 98 is configured to control the adjustable port 83 to control the quantity of the recirculated second airflow 44 and to control the temperature of the second airflow 44 within the enclosure 16.

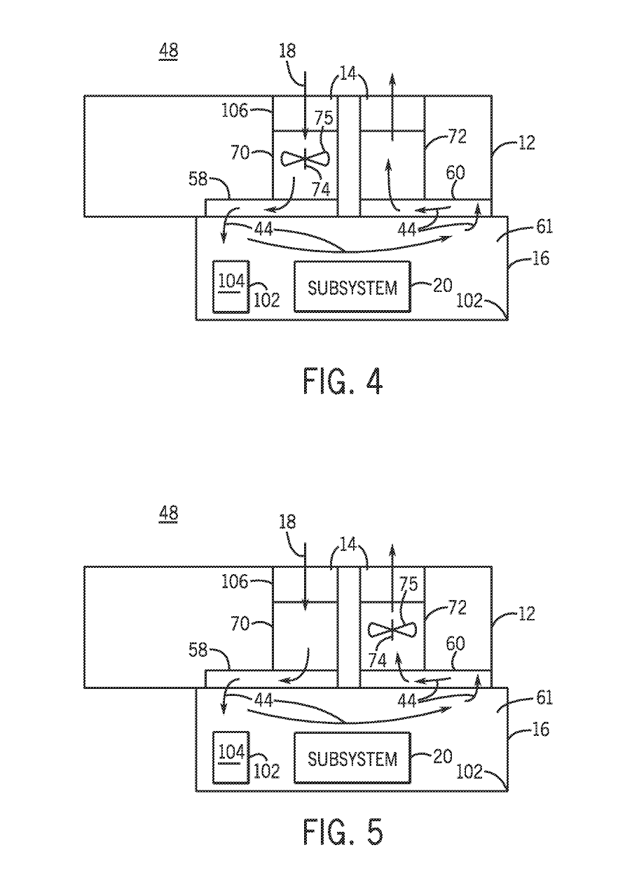

FIG. 4 illustrates an embodiment of an enclosure 16 that is positively pressurized by the modular ventilation system 14. A positively pressurized enclosure 16 may substantially isolate the enclosure 16 from the ambient environment 48. The enclosure 16 is positively pressurized when the pressure inside the enclosure 16 is greater than the pressure of the ambient environment 48. The second airflow 44 exerts a pressure on the inside of the enclosure 16 and at least some of the second airflow 44 may leak out of the enclosure 16 when the enclosure 16 is positively pressurized. For example, the second airflow 44 may leak out through seals 102 at edges of the enclosure 16 or ports 104 (e.g., doors, windows). More of the second airflow 44 may leak out through the seals 102 of the enclosure 16 than air from the ambient environment 48 leaks through the seals 102 into interior chamber 61. A fan 74 is configured to positively pressurize the enclosure 16 when it is configured to push the second airflow 44 into the enclosure 16. A positively pressurized enclosure may substantially prevent gases and particulates (e.g., sand, dust, biomass) from the ambient environment 48 from entering the enclosure 16. The inlet 70 and/or outlet 72 may include a filter 106 configured to substantially remove the gases and particulates from the second airflow 44 drawn from the ambient environment 48. Thus, positively pressurizing the enclosure 16 may substantially isolate the enclosure 16 from the ambient environment 48 except for the filtered air received through the inlet 70.

In contrast to FIG. 4, FIG. 5 illustrates an embodiment of an enclosure that is negatively pressurized by the modular ventilation system 14. A negatively pressurized enclosure 16 may substantially isolate the ambient environment 48 from the enclosure 16. The enclosure 16 is negatively pressurized when the pressure inside the enclosure 16 is less than the pressure of the ambient environment 48. The ambient environment 48 exerts a greater pressure on the outside of the enclosure 16 than the second airflow 44 exerts on the inside of the enclosure 16, and at least some of the ambient environment may leak into the interior chamber 61 when the enclosure 16 is negatively pressurized. For example, air 18, gases, and particulates of the ambient environment 48 may leak through the seals 102 at edges of the enclosure 16 or ports 104. The filter 106 in the inlet 70 is not configured to remove these gases and particulates from the enclosure 16. More of the air, gases, and particulates from the ambient environment 48 may leak into the interior chamber 61 through the seals 102 of the enclosure 16 than the second airflow 44 leaks through the seals 102 into the ambient environment 48. A fan 74 is configured to negatively pressurize the enclosure 16 when it is configured to pull the second airflow 44 from the enclosure 16. A negatively pressurized enclosure 16 may substantially prevent gases and particulates from the enclosure 16 from entering the ambient environment 48. A negatively pressurized enclosure 16 may be quieter than the same enclosure 16 when positively pressurized. In some embodiments, the negatively pressurized enclosure provides a better seal than the positively pressurized enclosure, such that there is less leakage across the seals 102 of the enclosure 16. For example, ports 104 that open outward may form a better seal when the enclosure 16 is negatively pressurized.

As illustrated in FIGS. 4 and 5, the modular ventilation system 14 enables the air intake 12 to readily change from an arrangement configured to positively pressurize the enclosure 16 to an arrangement configured to negatively pressurize the enclosure 16 by moving the fan 74 from the inlet 70 to the outlet 72 and switching the orientation of the fan 74 from pushing the second airflow 44 to pulling the second airflow 44. The pressurization of the enclosure 16 may be switched without affecting or substantially altering the structure of the inlet 70, inlet ducts 58, outlet 72, and/or outlet ducts 60. The direction of the second airflow 44 may be maintained when the location and orientation of the fan 74 are switched. The modular ventilation system 14 enables the fan 74 to be removably coupled as a modular unit to either the inlet 70 or the outlet 72 during operation of the turbomachine system 10. The air intake 12 may be configured to enable the fan 74 to be readily removed and coupled to either the inlet 70 or the outlet 72 in a push or pull configuration when the air intake 12 is initially assembled or when the air intake 12 is coupled to the enclosure 16 at an operational location (e.g., installation site).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
an air intake coupled to a turbomachine enclosure, wherein the air intake is configured to produce a first airflow and a second airflow, and the air intake comprises:
a conduit configured to direct the first airflow to a turbomachine subsystem within the turbomachine enclosure;
an inlet configured to removably couple with a fan and to direct the second airflow in a first direction;
an inlet duct coupled to the inlet, configured to direct the second airflow in a second direction at least partially around the conduit, and configured to direct the second airflow in a third direction into the turbomachine enclosure;
an outlet duct configured to receive the second airflow from the turbomachine enclosure from a fourth direction substantially opposite to the third direction, and configured to direct the second airflow in the second direction to an outlet;
the outlet configured to removably couple with the fan and to direct the second airflow from the turbomachine enclosure in a fifth direction; and
the fan, wherein the fan is disposed within the air intake, is removably coupled to the inlet or to the outlet, and is configured to positively or negatively pressurize the turbomachine enclosure with the second airflow based on the orientation and disposition of the fan.

2. The system of claim 1, comprising the turbomachine subsystem, wherein the turbomachine subsystem comprises a gas turbine.

3. The system of claim 1, wherein the inlet is proximate the outlet.

4. The system of claim 3, wherein the inlet and the outlet are disposed between the conduit and an exhaust outlet of the turbomachine enclosure.

5. The system of claim 4, wherein the inlet duct at least partially surrounds the conduit and the outlet duct at least partially surrounds the exhaust outlet.

6. The system of claim 1, wherein the inlet duct, the inlet, the outlet duct, and the outlet are integrally disposed within the air intake.

7. The system of claim 1, wherein the first direction and the fifth direction are substantially opposite.

8. The system of claim 1, wherein the fan is removably coupled to the inlet and is configured to positively pressurize the turbomachine enclosure, or the fan is removably coupled to the outlet and is configured to negatively pressurize the turbomachine enclosure.

9. The system of claim 1, wherein the inlet comprises a vent silencer.

10. The system of claim 1, wherein the outlet duct comprises a gas detector.

11. A system, comprising:
an enclosure surrounding a subsystem; and
an air intake coupled to the enclosure, wherein the air intake is configured to direct a first airflow to the subsystem and to direct a second airflow to the enclosure, and the air intake comprises:
an inlet duct coupled to the enclosure and configured to receive the second airflow;
an outlet duct coupled to the enclosure and configured to direct the second airflow; and
a fan, wherein the fan is removably coupled to the inlet duct to positively pressurize the enclosure or removably coupled to the outlet duct to negatively pressurize the enclosure.

12. The system of claim 11, wherein the fan is configured to removably couple within the air intake.

13. The system of claim 12, wherein the air intake is configured to attenuate fan noise.

14. The system of claim 11, wherein the first air inlet comprises a vent silencer.

15. The system of claim 11, wherein the subsystem comprises a gas turbine.

16. The system of claim 11, wherein the inlet duct is proximate the outlet duct.

17. The system of claim 11, wherein the inlet duct, the outlet duct, and the fan are integrally disposed within the air intake.

18. The system of claim 11, wherein the fan comprises a drive motor, a housing, and blades driven by the drive motor, wherein the fan is configured to direct the second airflow through the housing, and the drive motor is disposed outside the housing.

19. A method, comprising:
directing a first airflow through a conduit to a gas turbine system disposed within an enclosure;
receiving a second airflow from a first direction through an inlet configured to removably couple with a fan;
directing the second airflow in a second direction through an inlet duct at least partially around the first airflow;
directing the second airflow in a third direction through the inlet duct into the enclosure;
receiving the second airflow from a fourth direction substantially opposite to the third direction through an outlet duct from the enclosure;
directing the second airflow in the second direction to an outlet;
directing the second airflow in a fifth direction from the outlet configured to removably couple with the fan; and
pressurizing the enclosure with a positive or a negative pressure based on the orientation and disposition of the fan.

20. The method of claim 19, comprising cooling the gas turbine system, ventilating the enclosure, or sealing the enclosure from an external environment, or a combination thereof.
